(19) United States
(12) Patent Application Publication
(10) Pub. No.: US 2026/0164104 A1
(43) Pub. Date: Jun. 11, 2026

(54) FORENSIC SPECTRAL IMAGING UNIT

(71) Applicant: SMYTEC LTD, Lubenham (GB)

(72) Inventors: Alexander SMYTH, Leicester (GB); Robert THOMPSON, Leicester (GB)

(73) Assignee: SMYTEC LTD, Lubenham (GB)

(21) Appl. No.: 18/706,900

(22) PCT Filed: Nov. 3, 2022
(86) PCT No.: PCT/GB2022/052770

§ 371 Date: May 2, 2024

(30) Foreign Application Priority Data
Nov. 3, 2021 (GB) 2115788.8
Jul. 22, 2022 (GB) 2210753.6

(51) Int. Cl. H04N 23/16; H04N 23/56; H04N 23/698; H04N 23/74; H04N 23/90

(52) U.S. Cl. CPC H04N 23/16; H04N 23/56; H04N 23/698; H04N 23/74; H04N 23/90

(57) ABSTRACT

A forensic spectral imager for non-contact, non-destructive imaging of a forensic sample on a sample surface includes a light source having at least one wavelength causing one or more of absorption, fluorescence, reflectance and scattering by the forensic sample and/or the sample surface; a first optical imaging device having a first field of view, for capturing a forensic image of the forensic sample and/or the sample surface, within a scene, wherein the optical imaging device includes a pass filter having a wavelength band that corresponds to a wavelength of the absorption, fluorescence, reflectance and/or scattering by the forensic sample and/or the sample surface, the pass filter including a first pass filter having hyperspectral sensitivity; and wherein the forensic spectral imager comprises a second optical imaging device having a second field of view wider than the first field of view, for capturing one or more visible light frames of the scene.

### TECHNOLOGICAL FIELD

Embodiments of the present disclosure relate to a forensic spectral imaging unit and to a method of its operation. Some relate to a hand-portable forensic spectral imaging unit for carrying out non-contact, non-destructive imaging of one or more of: a skin mark or skin print; a bodily fluid; a drug; or an explosive substance or component; or a food substance.

### BACKGROUND

It is known to use physical or chemical enhancement contact techniques to collect finger mark information.

### BRIEF SUMMARY

Aspects of the invention provide a more robust evidentiary picture of the scene search and evidence recovery process.

According to an aspect of the invention there is provided a forensic spectral imaging unit for carrying out non-contact, non-destructive imaging of a forensic sample deposited on a sample surface, the forensic spectral imaging unit comprising:
a light source having at least one wavelength that is capable of causing one or more of absorption, fluorescence, reflectance and scattering by the forensic sample and/or the sample surface;
a first optical image capture device having a first field of view, for capturing at a first time at least one forensic image of the forensic sample and/or the sample surface, within a scene, wherein the optical image capture device includes at least one pass filter having a wavelength band that corresponds to a wavelength of the absorption, fluorescence, reflectance and/or scattering by the forensic sample and/or the sample surface, the at least one pass filter including a first pass filter being of hyperspectral sensitivity; and
a second optical image capture device having a second field of view wider than the first field of view, for capturing one or more visible light frames of the scene at one or more times including at the first time.

According to an aspect of the invention there is provided a method of operating a forensic spectral imaging unit to carry out non-contact, non-destructive imaging of a forensic sample deposited on a sample surface, the forensic spectral imaging unit in accordance with the above aspect, the method comprising:
capturing visible light frames of the scene with the second optical image capture device, at one or more times including at the first time;
exposing the forensic sample and the sample surface to the light source to cause one or more of absorption, fluorescence, reflectance and scattering by the forensic sample and/or the sample surface; and
   capturing at the first time the at least one forensic image of the forensic sample and/or the sample surface with the first optical image capture device using the at least one pass filter having a wavelength band that corresponds to a wavelength of the absorption, fluorescence, reflectance and/or scattering by the forensic sample and/or the sample surface, the at least one pass filter including a first pass filter being of hyperspectral sensitivity.

According to an aspect of the invention there is provided a forensic spectral imaging unit for carrying out non-contact, non-destructive imaging of a forensic sample deposited on a sample surface, the forensic spectral imaging unit comprising:
a light source having at least one wavelength that is capable of causing one or more of absorption, fluorescence, reflectance and scattering by the forensic sample and/or the sample surface;
a first optical image capture device having a first field of view, for capturing at a first time at least one forensic image of the forensic sample and/or the sample surface, within a scene, wherein the optical image capture device includes at least one pass filter having a wavelength band that corresponds to a wavelength of the absorption, fluorescence, reflectance and/or scattering by the forensic sample and/or the sample surface; and
   a control apparatus having a controller, the control apparatus configured to control operations of the light source and the first optical image capture device, wherein the control apparatus is configured to:
provide the at least one forensic image to a skin print identification system, wherein the forensic sample is a skin print;
receive a parameter dependent on how many skin print minutiae points are detected by the skin print identification system; and
output feedback based on the parameter, for rendering by an output device associated with the forensic spectral imaging unit.

According to an aspect of the invention there is provided a forensic spectral imaging unit for carrying out non-contact, non-destructive imaging of a forensic sample deposited on a sample surface, the forensic spectral imaging unit comprising:
a light source having at least one wavelength that is capable of causing one or more of absorption, fluorescence, reflectance and scattering by the forensic sample and/or the sample surface;
a first optical image capture device having a first field of view, for capturing at a first time at least one forensic image of the forensic sample and/or the sample surface, within a scene, wherein the optical image capture device includes at least one pass filter having a wavelength band that corresponds to a wavelength of the absorption, fluorescence, reflectance and/or scattering by the forensic sample and/or the sample surface; and
   a control apparatus having a controller, the control apparatus configured to control operations of the light source and the first optical image capture device, wherein the control apparatus is configured to:
provide the at least one forensic image to a matching system;
receive a match indicator indicating whether the forensic sample in the at least one forensic image corresponds to a forensic sample in a database, according to the matching system; and
output match feedback based on the match indicator, for rendering by an output device associated with the forensic spectral imaging unit.

According to an aspect of the invention there is provided a forensic spectral imaging unit for carrying out non-contact, non-destructive imaging of a forensic sample deposited on a sample surface, the forensic spectral imaging unit comprising:
a light source having at least one wavelength that is capable of causing one or more of absorption, fluorescence, reflectance and scattering by the forensic sample and/or the sample surface;
a first optical image capture device having a first field of view, for capturing at a first time at least one forensic image of the forensic sample and/or the sample surface, within a scene, wherein the optical image capture device includes at least one pass filter having a wavelength band that corresponds to a wavelength of the absorption, fluorescence, reflectance and/or scattering by the forensic sample and/or the sample surface. According to the aspect of the invention the forensic spectral imaging unit may further comprise one or more of:
a location sensor configured to detect a location of the forensic spectral imaging unit, and to provide information indicative of the location as metadata for the at least one forensic image;
an onboard clock apparatus configured to provide timestamp information as metadata for the at least one forensic image; or
a controller configured to provide image settings information as metadata for the at least one forensic image.

According to an aspect of the invention there is provided a forensic spectral imaging unit for carrying out non-contact, non-destructive imaging of at least one forensic sample deposited on at least one sample surface, the forensic spectral imaging unit comprising:
a light source having at least one wavelength that is capable of causing one or more of absorption, fluorescence, reflectance and scattering by the at least one forensic sample and/or the at least one sample surface;
a first optical image capture device having a first field of view, for capturing at a first time at least one forensic image of the at least one forensic sample and/or the at least one sample surface, within a scene, wherein the optical image capture device includes at least one pass filter having a wavelength band that corresponds to a wavelength of the absorption, fluorescence, reflectance and/or scattering by the at least one forensic sample and/or the at least one sample surface; and
a control apparatus having a controller, the control apparatus configured to control operations of the light source and the first optical image capture device, wherein the control apparatus is configured to:
provide the at least one forensic image to a bloodstain pattern analysis system, wherein each of the at least one forensic sample comprises a directional blood droplet;
receive a parameter from the bloodstain pattern analysis system, wherein the parameter is indicative of a source location or direction of the at least one forensic sample based on a shape of the directional blood droplet; and
output guidance based on the parameter, to be rendered by an output device associated with the forensic spectral imaging unit to guide a user of the forensic spectral imaging unit towards the source location.

The forensic spectral imaging unit may comprise a control apparatus. The control apparatus may be applicable to any one or more of the preceding aspects.

The control apparatus may comprise a bloodstain pattern analysis system as described above. The bloodstain pattern analysis system may comprise a trained machine learning algorithm. The guidance from the bloodstain pattern analysis system may be output in real-time. An advantage is that the searcher can be guided towards the parts of the scene where the search is more likely to discover critical evidence.

The at least one pass filter of any of the preceding aspects may be of hyperspectral sensitivity defined as a full width at half maximum (FWHM) less than or equal to 10 nm.

The first optical image capture device may comprise a plurality of selectable pass filters including a first pass filter having a FWHM less than or equal to 10 nm (hyperspectral sensitivity), and a second pass filter having a FWHM greater than 10 nm (not hyperspectral sensitivity).

The second pass filter may have a FWHM greater than 25 nm (nanometres) or greater than 80 nm. An advantage is that during the initial search process, many types of evidence can be detected and viewed simultaneously, such as fingermarks and bodily fluids.

The first optical image capture device may comprise a first plurality of pass filters having a FWHM less than or equal to 10 nm, and second plurality of pass filters having a FWHM greater than 10 nm. The first plurality of pass filters can include a shortwave UV filter, a longwave UV filter, a visible filter, for example. The second plurality of pass filters can include one or more UV filters such as a UV shortpass filter, a longwave UV filter, for example. The first plurality of pass filters may have non-overlapping bands compared to each other. The second plurality of pass filters may have non-overlapping bands compared to each other.

The forensic spectral imaging unit may comprise a depth sensor. The depth sensor may comprise a time of flight sensor or a light detection and ranging (LIDAR) sensor. The control apparatus may store a depth map or a measurement of working distance in combination with the at least one forensic image.

The control apparatus may be configured to overlay a scale indicator within the at least one forensic image based on depth information from the depth sensor. The at least one forensic image may be stored with the overlaid scale indicator in non-volatile memory. An advantage is that the search does not need to place a physical scale bar on the surface next to the evidence.

The first optical image capture device may comprise a polariser. An advantage of the polariser is removal of background noise on reflective surfaces in well-lit environments.

The polariser may be an ultraviolet polariser. An advantage is that ultraviolet reflections from sunlight are removed.

The polariser may be connectable to and disconnectable from the forensic spectral imaging unit. The polariser may be disconnectable by a user. An advantage is greater flexibility for the user.

The control apparatus may be operable in a plurality of modes, each mode controlling two or more of the following settings:
a wavelength of the light source;
a pass filter selection from a plurality of pass filters;
image settings of an imaging sensor of the first optical image capture device.

In a fingermark mode and/or bodily fluid mode of the plurality of modes, the control apparatus may be configured to enable selection of one or more presets. Each preset may comprise a different combination of a pass filter and a wavelength of the light source.

In a post-blast mode of the plurality of modes, the control apparatus may be configured to select a higher exposure time of the imaging sensor.

In a manual mode of the plurality of modes, the control apparatus may be configured to enable manual control of two or more of the following settings: a wavelength of the light source; a pass filter selection; image settings of the imaging sensor. One or more of the settings may be locked in one or more of the other modes.

The forensic spectral imaging unit may comprise a still image capture trigger for causing the first and/or second optical image capture device to record a still image in non-volatile memory. The still image capture trigger may comprise a human-machine interface such as a button or touchscreen control.

The control apparatus may be configured to combine the at least one forensic image with a secondary image captured by the second optical image capture device to form a combined image, in which the position of the forensic sample from the at least one forensic image corresponds to the position of the forensic sample from the secondary image. The control apparatus may be configured to store the combined image in non-volatile memory. An advantage is improved evidence documentation because the combined image places the forensically-imaged sample within a context of the larger scene.

Combining the at least one forensic image with an image captured by the second optical image capture device may comprise overlaying the at least one forensic image onto the image captured by the second optical image capture device.

The control apparatus may be configured to cause display of the combined image on a display of the forensic spectral imaging unit. The at least one forensic image and secondary image may be still images. The combined image may be a combined still image. The still images may be captured and stored in non-volatile memory in response to user actuation of the still image capture trigger.

The secondary image may be a three-dimensional image, captured by the depth sensor. Combining the at least one forensic image with the secondary image may comprise overlaying the at least one forensic image at a three-dimensional position within the secondary image.

The metadata for the at least one forensic image may comprise a barcode identity. An advantage is that the user can digitally record the number of a barcode placed into the field of view of the second optical image capture device.

The control apparatus may include an electronic image processing circuit programmed to carry out image processing of the at least one forensic image. The control apparatus may be configured to enable user control of the electronic image processing circuit to process captured forensic images stored in non-volatile memory. The control apparatus may enable user control of at least one of: brightness; contrast; sharpness; orientation; negative transformation. The control apparatus may be configured to cause display of the processed forensic image. An advantage is enabling live assessment of the quality of the recording of the evidence, while they are still at the scene. An advantage of negative images is that they can be easier to interpret.

The forensic spectral imaging unit may comprise a display port for connecting the forensic spectral imaging unit to an external display. An advantage is that evidence can be assessed at the scene on a larger screen.

The forensic spectral imaging unit may comprise a display. The forensic spectral imaging unit may comprise a hood above the display. An advantage is that the display is less affected by glare.

### BRIEF DESCRIPTION

Some examples will now be described with reference to the accompanying drawings in which:

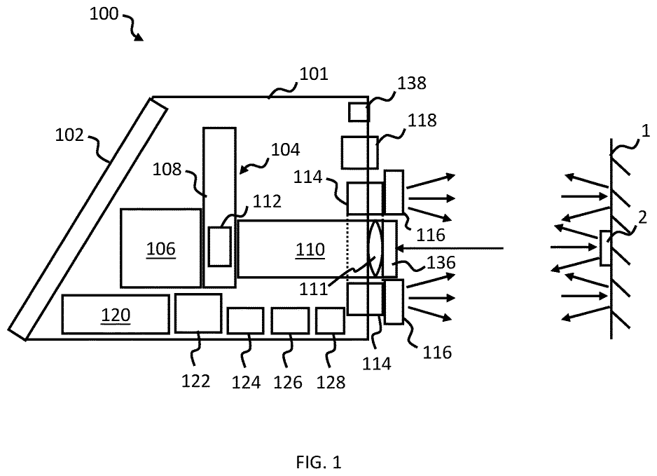

FIG. 1 illustrates an example of a forensic spectral imaging unit;

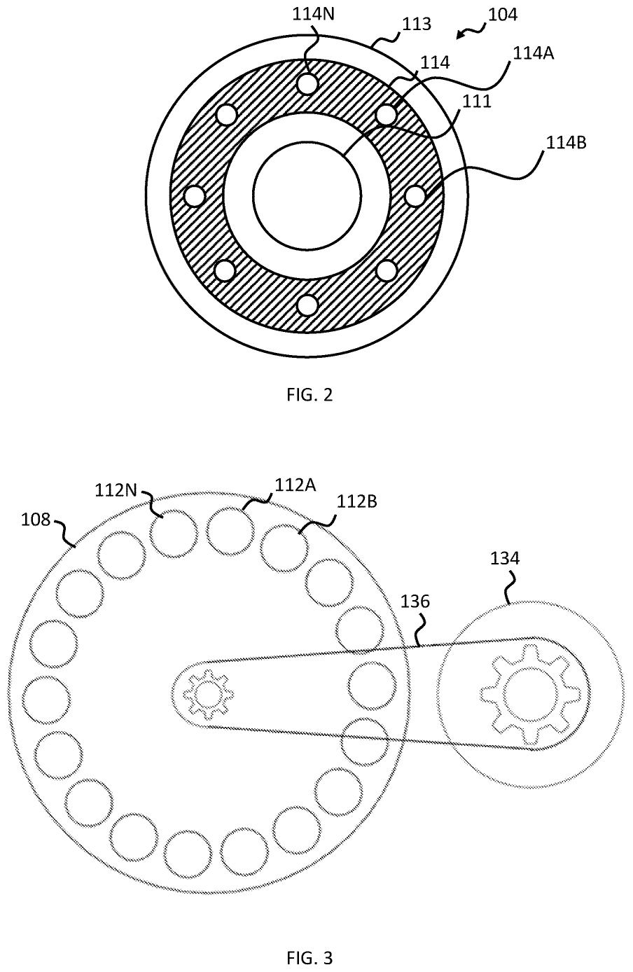

FIG. 2 illustrates an example of a light source around a first optical image capture device;

FIG. 3 illustrates an example of a plurality of pass filters and a filter exchange mechanism;

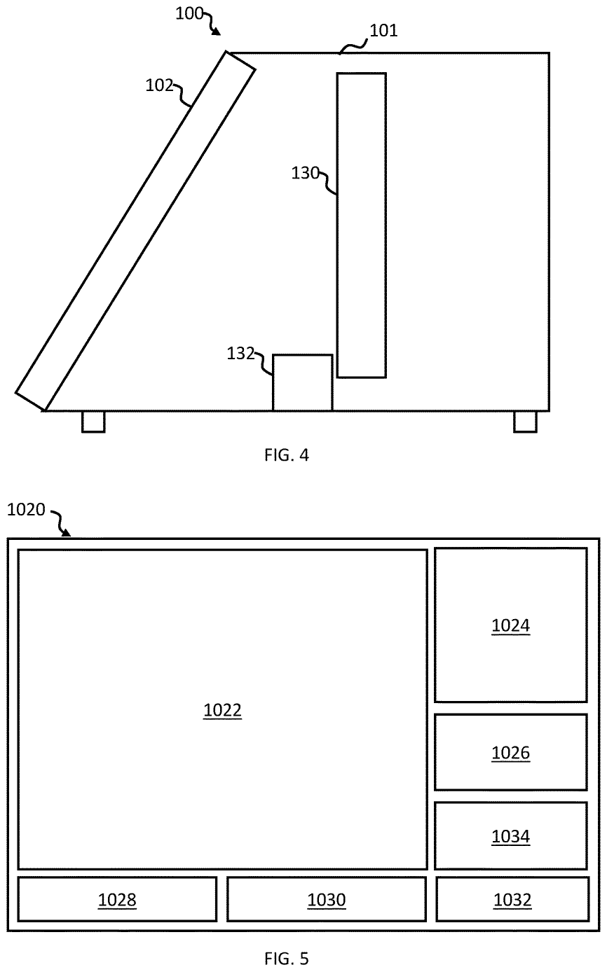

FIG. 4 illustrates an example of external components of a hand-portable forensic spectral imaging unit.

FIG. 5 illustrates an example of user interface functional blocks;

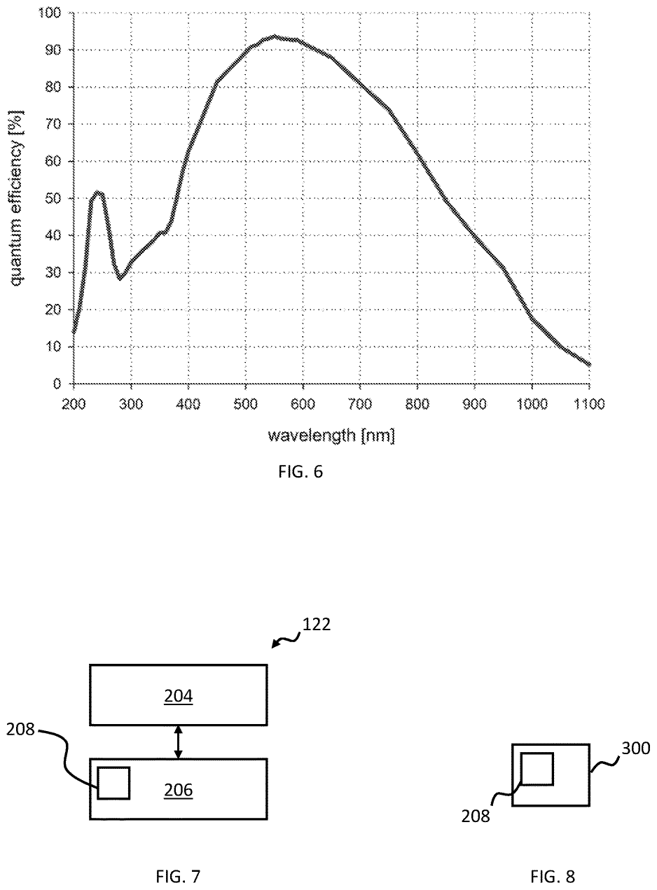

FIG. 6 illustrates an example of the quantum efficiency of a UV-enhanced CMOS sensor;

FIG. 7 illustrates an example of a control apparatus;

FIG. 8 illustrates an example of a non-transitory computer-readable storage medium;

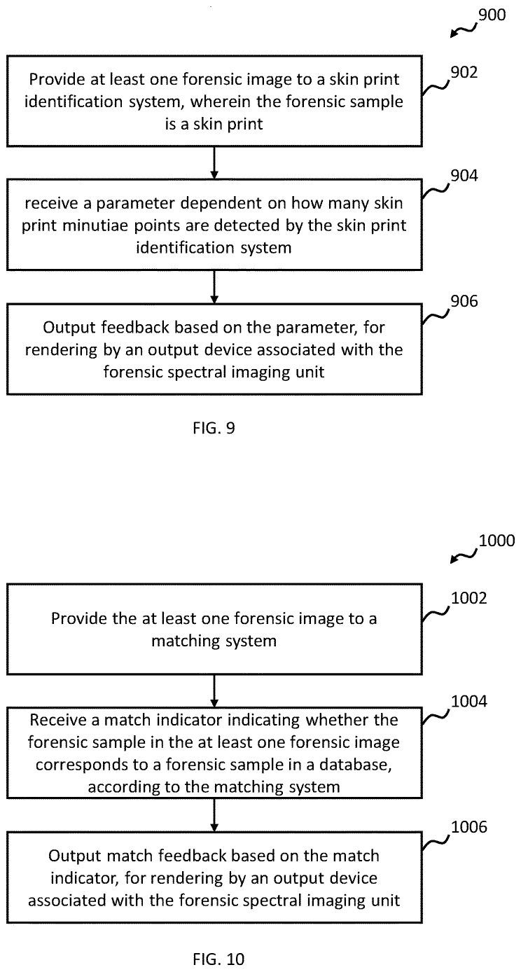

FIG. 9 illustrates an example of a quality feedback method;

FIG. 10 illustrates an example of a match feedback method; and

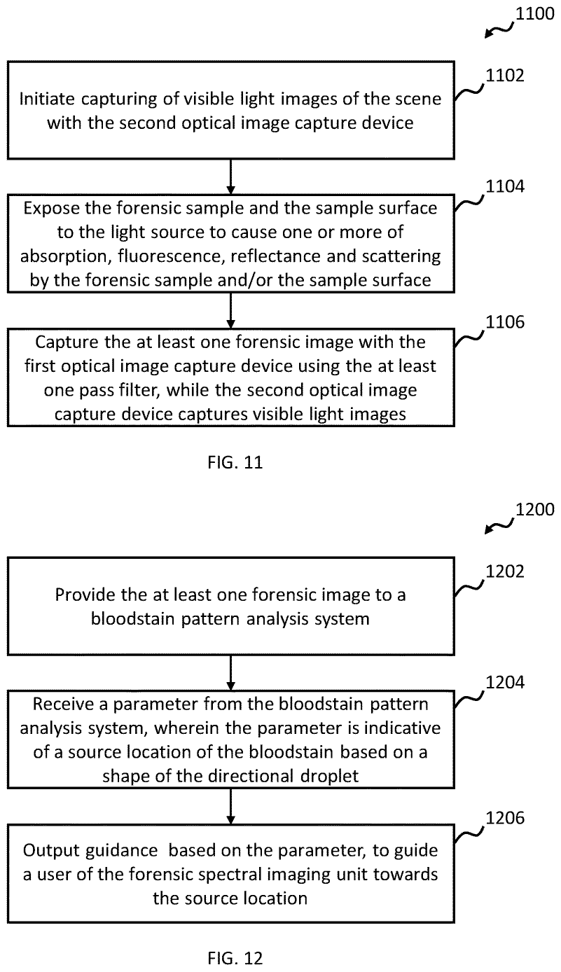

FIG. 11 illustrates an example of a method of operating a forensic spectral imaging unit;

FIG. 12 illustrates an example of a bloodstain source locating method;

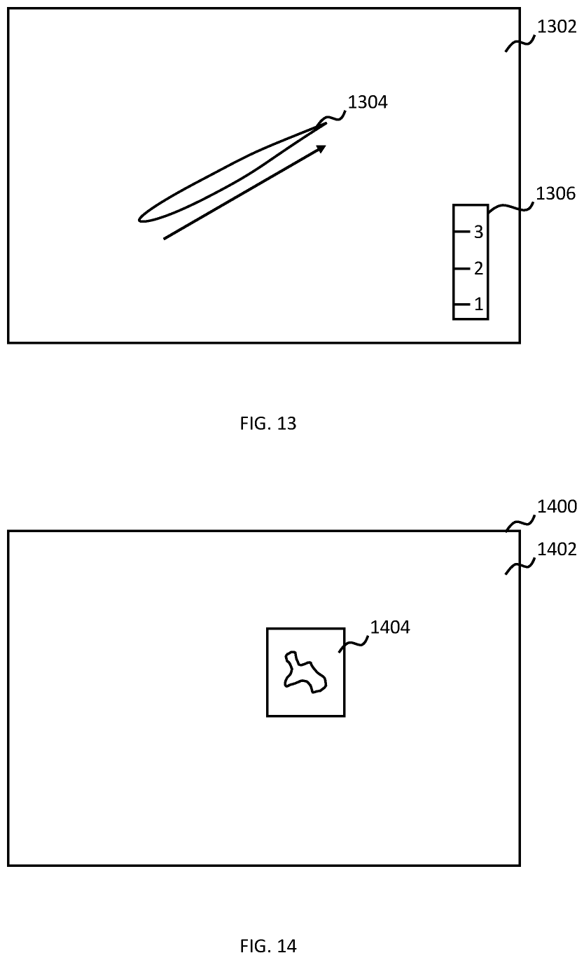

FIG. 13 illustrates an example of a forensic image showing a bloodstain; and

FIG. 14 illustrates an example of a combined image.

### DETAILED DESCRIPTION

The Figures illustrate an example forensic spectral imaging unit 100 and methods 900, 1000, 1100 of its use, for carrying out non-contact, non-destructive imaging of a forensic sample 2 deposited on a sample surface 1.

The non-contact and non-destructive nature of the invention preserves the forensic samples as evidence for other analyses, such as DNA profiling or chemical testing. The invention does not require the use of pre-imaging contact-based preparation of the forensic sample, such as dye staining, powdering or superglue fuming of the forensic sample 2.

FIG. 1 illustrates an example of a forensic spectral imaging unit 100 and schematically illustrates its components. Any components not explicitly stated or claimed as essential are optional. The illustrated forensic spectral imaging unit 100 is being pointed at a forensic sample 2 on a sample surface 1.

The forensic sample 2 can comprise any one or more of: a skin mark or skin print; a bodily fluid (such as blood or semen); a drug; or an explosive substance or component (including explosive fragments and explosive residue); or a food substance (such as herbs or spices such as saffron).

It will be understood that the skin mark or print may be, but is not limited to, a finger mark or print, a thumb mark or print, a hand mark or print, a palm mark or print, a toe mark or print, or a foot mark or print. It will also be understood that the skin mark or print may be a latent or patent skin mark or print. The sample surface 1 can be either of a porous surface or a non-porous surface. The sample surface 1 can be either of a plane surface or a non-plane surface such as a curved surface.

The forensic spectral imaging unit 100 comprises a light source 114 and a first optical image capture device 104. Both the light source 114 and the first optical image capture device 104 are housed or mounted in or on a housing 101.

The light source 114 is configured to emit light towards the sample. The light source 114 has at least one wavelength that is capable of causing one or more of absorption, fluorescence, reflectance and scattering by the forensic sample 2 and/or the sample surface 1. The light source 114 may have a plurality of selectable wavelengths.

The light source 114 comprises at least one of the following emitter types 114A-114N: an infrared or near-infrared light emitter 114A; an ultraviolet light emitter 114B; a broadband white light source 114N. The light source 114 may be light emitting diode (LED)-based. The light source 114 may comprise a plurality of LEDs. The LEDs may have respective emission wavelengths that correspond to UV, visible, infrared and near-infrared light wavelengths. Exemplarily these wavelengths may include approximately 254 nm, approximately 302 nm, approximately 365 nm, approximately 450 nm, approximately 530 nm, approximately 570 nm, etc. A broadband white light source 114N (approx. 400 nm-700 nm or 400 nm-800 nm spectral range) may also be included and is described later.

Other types of light sources (such as gas-filled lighting elements) and other wavelengths are envisaged, for example for the 365 nm, 302 nm and 254 nm light sources, to provide more energy than LEDs, and further for the infrared and/or near-infrared source(s).

Table 1 below provides rationale for the use of the above wavelengths:

| LED | |
|---|---|
| Wavelength | |
| Group (nm) | Rationale for Use |
| 365 | Fingermarks: Excitation of Lysine amino acid at this wavelength will result in fluorescence at 435 nm; |
| | absorption contrast between fingermark and surface; scatter contrast between fingermark and surface; |
| | reflection contrast between fingermark and surface. |
| | Blood: Absorption shift between oxy- and deoxy-hemoglobin at this excitation |
| | Semen: Absorption at 365 nm will result in bright fluorescence around 500 nm. |
| | Drugs & Explosive: different absorption and fluorescence properties at 365 nm excitation enabling |
| | differentiation between substances |
| 405 | Blood or Semen: illumination of old blood and old semen. The other wavelengths were found not to be |
| | effective on years-old bloodstains. However, this wavelength (violet) was found to be effective. |
| 450 | Fingermarks: absorption contrast between fingermark and surface; scatter contrast between fingermark |
| | and surface; reflection contrast between fingermark and surface. |
| | Blood: Soret band region of very high but differing absorbance between oxy-, deoxy-, and met- |
| | hemoglobin. |
| | Semen: Excitation at 450 nm results in bright fluorescence at 515 nm; greatest fluorescence of semen |
| | at this excitation wavelength. |
| | Drugs & Explosive: different absorption and fluorescence properties at 450 nm excitation enabling |
| | differentiation between substances. |
| 530 | Fingermarks: absorption contrast between fingermark and surface; scatter contrast between fingermark |
| | and surface; reflection contrast between fingermark and surface. |
| | Blood: similar absorption properties for oxy-, deoxy-, and met-hemoglobin. |
| | Semen: Excitation at 530 nm results in fluorescence at longer wavelength. |
| | Drugs & Explosive: different absorption and fluorescence properties at 530 nm excitation enabling |
| | differentiation between substances. |
| 570 | Fingermarks: absorption contrast between fingermark and surface; scatter contrast between fingermark |
| | and surface; reflection contrast between fingermark and surface. |
| | Blood: Large contrast between absorption properties of oxy-, deoxy-, and met-hemoglobin at 570 nm. |
| | Semen: Excitation at 570 nm results in fluorescence at longer wavelength. |
| | Drugs & Explosive: different absorption and fluorescence properties at 570 nm excitation enabling |
| | differentiation between substances. |
| White Light | Used in combination with hyperspectral sensitivity bandpass filters to isolate fluorescent regions for |
| | blood and semen across the spectrum. |

FIG. 2 illustrates an example implementation of the light source 114. The light source 114 comprises a ring light 113 that is attached to the front of a lens 111 of optics 110 of the first optical image capture device 104. The ring light 113 may be permanently or detachably attached to the front of the lens 111. The optical axis of the lens 111 may be substantially coaxial with a central axis of the ring light 113.

Although not shown in FIG. 2, the ring light 113 may comprise a plurality of groups of light emitters. Each group can comprise a plurality of light sources each group having a different emission wavelength than each other group.

The total size of each group may be three or more light emitters, to ensure emission of spatially-uniform high-intensity light. The maximum intensity (radiant flux) of a single light emitter of a given wavelength may be a value from the range 400 mW to 2000 mW. The maximum combined intensity when all the light emitters of a given wavelength are emitting may be a value from the range 2400 mW to 8000 mW.

The full width at half maximum (FWHM) of the light emitter wavelength of at least some of the above light emitters may be less than approximately 100 nm, such as less than approximately 40 nm.

The light source 114, such as the ring light 113, may be covered by a window 116 having a uniform transmission capability of greater than 70% across the spectral range 190 nm to 1400 nm. An example of the window 116 is a synthetic fused silica window.

The lens 111 of the first optical image capture device 104 is exemplarily a 105 mm F4.5 Telephoto Lens with macro capability. The lens 111 may be UV-enhanced. The transmission capability of the lens 111 includes from 220 nm to 900 nm, with transmission greater than 70% throughout this range. Incident light is received through the lens 111 and into the forensic spectral imaging unit 100. The interior of the housing 101 may be anodised to reduce extraneous light scatter within the first optical image capture device 104. In some examples, some external components may be anodised for similar reasons.

The optics 110 may comprise a plurality of aperture stops, to enable accurate imaging of both flat and curved surfaces. The optics 110 may comprise more than two aperture stops, for example more than four aperture stops (e.g., seven aperture stops), to provide enough control to enable sharp imaging of a range of curved surfaces. Manually controllable parameters include, for example, the aperture stops, magnification, focal distance and imaging distance, to enable the user to have the following working distance and field of view capabilities:
minimum working distance: 30 cm or less
field of view at minimum working distance: 2 cm²

The first optical image capture device 104 includes an imaging sensor 106 and a plurality of pass filters 112 in the housing 101. The pass filters 112 are arranged between the imaging sensor 106 and the optics 110 so that the imaging sensor 106 receives light through the optics 110 and a selected one of the pass filters 112.

The configuration of the forensic spectral imaging unit 100 therefore enables the light source 114 to emit light at a plurality of wavelengths and the first optical image capture device 104 to capture forensic images using a plurality of pass filters 112 and store the forensic images in non-volatile memory (e.g., memory 206 of FIG. 7).

The imaging sensor 106 can comprise an ultraviolet imaging sensor with sensitivity ranging from 190 nm to 1100 nm. The resolution of the imaging sensor 106 may be at least in the Megapixel range. The quantum efficiency of the imaging sensor 106 is shown in FIG. 6. Optionally, the imaging sensor 106 can be cooled.

The imaging sensor 106 may be a CMOS-based imaging sensor. In other embodiments, the imaging sensor 106 may be a CCD-based imaging sensor.

Each pass filter 112 has a wavelength band that corresponds to a wavelength of the absorption, fluorescence, reflectance and/or scattering by a predetermined type of forensic sample 2 and/or sample surface 1.

The pass filters 112 may include a single-bandpass filter, a dual-bandpass filter, a quad-bandpass filter, a longpass filter or a shortpass filter. The pass filters 112 may include bandpass filters of hyperspectral sensitivity, and one or more bandpass filters not of hyperspectral sensitivity.

Example pass filters 112 include: a UV short pass filter; a UV long pass filter; a multi-band fluorescence bandpass filter; a bandpass interference filter; a narrowband fluorescence bandpass filter for a specific fluorophore; and/or a broadband fluorescence bandpass filter for a specific fluorophore.

One or more of the pass filters 112 has a peak wavelength selected from the range 250 to 380 nm (ultraviolet), with transmission greater than or equal to 50%. One or more of the pass filters 112 has a peak wavelength selected from the range 380 to 720 nm (visible), with transmission greater than or equal to 50%. The full width at half maximum (FWHM) of at least some of the above pass filters 112 may be less than approximately 20 nm, such as less than or equal to approximately 10 nm (hyperspectral sensitivity). This means a pass filter 112 having a narrow wavelength and giving hyperspectral type spectral resolution.

The precise peak wavelength is chosen based on the filter's spectral properties in combination with the light source 114 to be used and the evidence type to be analysed, including the surface on which the evidence type is deposited.

The above-described arrangement offers the ability to utilize multi-spectral imaging with hyperspectral sensitivity as well as the flexibility to reduce the sensitivity from hyperspectral when this is appropriate, for example with tryptophan fluorescence, by using different filter types.

In some examples, the pass filters 112 are mounted onto a filter exchange mechanism such as a multi-position filter wheel 108, an example of which is illustrated in FIG. 3. The filter wheel 108 may be a motorised filter wheel 108, actuatable to locate a selected pass filter 112, of a plurality of pass filters 112A-112N of the filter wheel 108, between the optics 110 and the imaging sensor 106. This allows the selection of a single filter of interest or the usage of multiple filters sequentially.

The actuator 134 of the filter wheel 108 may comprise a stepper motor, connected to the filter wheel 108 by a drive mechanism 136 such as a belt. An encoder for controlling the stepper motor may have more than 1000 positions, to offer an accuracy of greater than 0.36 degrees.

Referring back to FIG. 1, the forensic spectral imaging unit 100 further comprises a second optical image capture device 118. The second optical image capture device 118 is configured to capture visible light frames, such as video, of a larger scene within which the forensic sample 2 and forensic surface are located. The frames may be stored in non-volatile memory. The second optical image capture device 118 therefore provides contextual information, akin to metadata. The video footage can be used as supporting evidence to help give a clearer overview of the scene where evidence is being taken. This provides a more robust evidentiary picture of the scene search and evidence recovery process.

In another embodiment, the second optical image capture device 118 captures a still image when it is activated.

The second optical image capture device 118 has a wider field of view than that of the first optical image capture device 104. For example, the horizontal and/or vertical field of view of the second optical image capture device 118 may be a value greater than 40 degrees, or a value greater than 80 degrees, or a value greater than 135 degrees. By contrast, the horizontal and/or vertical field of view of the first optical image capture device 104 may be less than 40 degrees, or less than or equal to approximately 25 degrees.

In examples, the second optical image capture device 118 is positioned on a same (front) face of the housing 101 as the first optical image capture device 104. The second optical image capture device 118 has separate optics.

The optical axis of the lens of the second optical image capture device 118 may be parallel to and offset from the optical axis of the lens 111 of the first optical image capture device 104. The first and second optical image capture device 118s are relatively positioned and relatively oriented (e.g., parallel) so that the field of view of the first optical image capture device 104 is substantially within the field of view of the second optical image capture device 118. The offset can be small enough that the forensic sample 2 and sample surface 1 appears in the fields of view of both the first and second image capture devices, at the minimum working distance (e.g., 21 cm) to the forensic sample 2.

The second optical image capture device 118 may comprise a colour-sensor such as a sensor with a RGB (red-green-blue) Bayer filter.

Alternatively, the Bayer filter of the second optical image capture device 118 may be omitted to reduce the lower wavelength limit of the second optical image capture device 118 to faintly detect wavelengths of approximately 365 nm or less (e.g., very faintly detects 302 nm). This means that the video recording of the second optical image capture device 118 will visibly verify that the light source 114 is emitting ultraviolet light and/or that the forensic sample 2 or sample surface 1 is fluorescing/reflecting ultraviolet light. Therefore, the second optical image capture device 118 can provide evidence that both visible light investigations and ultraviolet light investigations have been carried out using the first optical image capture device 104.

The light source 114 of the forensic spectral imaging unit 100 can further comprise a broadband white light source 114N. By controlling the broadband white light source 114N to emit broadband white light, at least a portion of the scene is illuminated. By continuously emitting the broadband white light, video evidence of a dark scene can be collected by the second optical image capture device 118. The light can also help the operator with visual search of the scene.

The broadband white light source 114N may be part of the ring light 113. The broadband white light source 114N may be LED-based. Each group of light emitters can comprise a broadband white light emitter, for example.

The broadband white light source 114N may also be used in the capture of visible light forensic images by the first optical image capture device 104, with the selection of an appropriate filter. This improves versatility, enabling not only identification of fingermarks but also identification of other trace evidence such as blood, semen, drugs, explosives, and/or saffron.

The forensic spectral imaging unit 100 can further comprise a location sensor 124 to provide location metadata to supplement that provided by the second optical image capture device 118. The location sensor 124 is configured to detect a location of the forensic spectral imaging unit 100. The location sensor 124 can comprise a Global Positioning System (GPS) sensor or the like.

The location sensor 124 is configured to provide information indicative of the location as location metadata for the at least one forensic image of the first optical image capture device 104 and/or as location metadata for the video of the second optical image capture device 118. The location metadata may be stored in non-volatile memory in the metadata part of the image/video files, or as separate files.

The location sensor 124 may be configured to record a timestamp. This is a feature of GPS sensors. The location sensor 124 may be configured to provide timestamp information as time metadata for the at least one forensic image of the first optical image capture device 104 and/or as time metadata for the video of the second optical image capture device 118. The time metadata may be stored in non-volatile memory in the metadata part of the image/video files, or as separate files. The location and time metadata from the location sensor 124, with the video, provide a more robust evidentiary picture of the scene search and evidence recovery process.

Additionally, or alternatively, the forensic spectral imaging unit 100 can comprise an onboard clock 128. The onboard clock 128 can provide backup time metadata for when the location sensor 124 does not have connectivity.

A controller of the first optical image capture device 104 and/or of the light source 114 may be configured to provide image settings information as metadata for the forensic images. The image settings metadata may be stored in non-volatile memory in the metadata part of the forensic image files, or as separate files. The image settings metadata, together with other forms of metadata, provides a more robust evidentiary picture of the scene search and evidence recovery process.

The image settings information may indicate which one of a plurality of filters of the first optical image capture device 104 was selected when capturing the at least one forensic image.

The image settings information may indicate which one of a plurality of excitation wavelengths of the light source 114 was selected when capturing the at least one forensic image.

In some, but not necessarily all examples, the image settings information may indicate which one of a plurality of aperture stops of the first optical image capture device 104 was selected when capturing the at least one forensic image. In some, but not necessarily all examples, the image settings information may indicate which one of a plurality of lens focus positions was selected when capturing the at least one forensic image.

The image settings information may indicate at least one sensor property of the first optical image capture device 104 selected when capturing the at least one forensic image. Example sensor properties include, without limitation: exposure time (shutter speed/integration time); histogram equalisation; minimum histogram value; maximum histogram value; brightness; contrast; sharpness; gamma.

The forensic spectral imaging unit 100 can comprise an onboard power source 120 for powering the light source 114 and the first optical image capture device 104, such as an electrical energy storage means. The electrical energy storage means can comprise a battery, for example. This supports a hand-portable implementation of the forensic spectral imaging unit 100, for use in unfamiliar scenes where electricity may not be available. The onboard power source 120 may be rechargeable and/or user-removable from a compartment that is hand-openable. The forensic spectral imaging unit 100 can further comprise a power interface to receive external power.

The forensic spectral imaging unit 100 may be hand-portable. The dimensions and weight of the forensic spectral imaging unit 100 may be selected so that the forensic spectral imaging unit 100 can be used as a handheld imaging unit 100.

FIG. 4 provides an example of hand-portability features of the forensic spectral imaging unit 100. The illustrated forensic spectral imaging unit 100 comprises a side handle 130. A side handle 130 may be provided to each (left and right) side of the forensic spectral imaging unit 100. A user can slot their fingers and/or hands through each respective side handle 130, and/or can grip each side handle 130 itself.

FIG. 4 also illustrates that the hand-portable forensic spectral imaging unit 100 can comprise a tripod mount 132 at its base. The tripod mount 132 may comprise a screw fitting or a plug-socket connection or any other appropriate user-releasable connection.

The forensic spectral imaging unit 100 further comprises a control apparatus 122. The control apparatus 122 comprises a controller. The controller may be configured as a computer. The control apparatus 122 is configured to control operations of the light source 114 and the first optical image capture device 104 and the second optical image capture device 118. The control apparatus 122 can be configured to control movement of the filter wheel 108.

FIG. 7 schematically illustrates an example control apparatus 122. FIG. 8 schematically illustrates an example of a non-transitory computer-readable storage medium comprising instructions that, when executed by the control apparatus 122, enables one or more of the methods 900, 1000, 1100 described herein to be performed. These Figures are described in more detail later.

The control apparatus 122 can be user-operable to control the first optical image capture device 104 to capture forensic images while the second optical image capture device 118 continuously and automatically captures visible light frames as video footage or as a sequence of still images. A forensic image captured at a first time is complemented by a visible light frame image of the scene, captured substantially simultaneously (i.e., at the first time) by the second optical image capture device 118.

In an example, multiple forensic images of the same forensic sample 2, each having a different timestamp and captured through a different pass filter 112, may have timestamps occurring between the start and end timestamps of a single video captured by the second optical image capture device 118. The changes of pass filters 112 do not affect the bandpass of the second optical image capture device 118, because the optics of the second optical image capture device 118 does not include the pass filters 112.

In a use case, the user can start a video recording session and then capture a plurality of forensic images, and then end the video recording session. In an example, the control apparatus 122 only enables forensic images to be captured when a session is running (so that the second optical image capture device 118 is recording evidentiary video/frames).

The forensic images and associated metadata may be stored in non-volatile memory of the control apparatus 122 and may be exportable from the control apparatus 122 to an external computer via an input/output interface 126 of the forensic spectral imaging unit 100. The input/output interface 126 can comprise a physical interface, such as a Universal Serial Bus interface, and/or can comprise a wireless interface, such as a wireless local area network interface (e.g., Wi-Fi,™) and/or a wireless personal area network interface (e.g., Bluetooth,™).

The forensic spectral imaging unit 100 further comprises a human-machine interface 102 for enabling user control of functions of the control apparatus 122.

The human-machine interface 102 comprises an output device. The output device may comprise a display. The output device may be part of an input/output device, such as a touchscreen display. In some examples, separate input devices can be provided. The control apparatus 122 can be configured to receive and/or send signals from/to the human-machine interface 102. The human-machine interface 102 can be located at a rear face of the forensic spectral imaging unit 100, such as a rear face of the housing 101.

The display forming at least part of the human-machine interface 102 may be upwardly inclined or hinged so that it is not perpendicular to the optical axis of the first optical image capture device 104 and is more easily viewable from above. The display may be inclined by an angle selected from the range 20 degrees to 70 degrees, such as approximately 35 degrees.

This improves ergonomics of the forensic spectral imaging unit 100 because the display is perpendicular to the user's eyes while the unit positioned below the user's eye level (e.g., close to ground level) for forensic investigations.

FIG. 5 illustrates a functional block diagram 1020 comprising specific functional blocks 1022-1032. In an implementation, each functional block represents computer program component stored in memory that, when executed by a processor, causes the output device of the human-machine interface 102 to be controlled to provide the function of the functional block, such as rendering a user interface on the output device of the human-machine interface 102. The specific functions may be rendered at the same time or at different times, in any suitable layout.

FIG. 5 illustrates a forensic image component 1022. The forensic image interface component 1022 may be configured to render forensic images captured by the first optical image capture device 104.

The forensic image component 1022 may further be configured to render a ‘live-mode’ user interface showing real-time footage captured by the first optical image capture device 104. This enables the user to check the focus, magnification and aperture opening before capturing a forensic image, to ensure it is of a good quality to be analysed. Starting a session may automatically initiate ‘live-mode’ rendering on the human-machine interface 102.

The forensic image component 1022 may be configured to render user input controls to enable a user to control image settings of the imaging sensor 106. The control may include any one or more of: selection of an aperture stop; selection of magnification; selection of focal length; selection of exposure time; selection of histogram equalisation; selection of minimum histogram value; selection of maximum histogram value; selection of brightness; selection of contrast; selection of sharpness; selection of gamma. At least some of these settings may be recorded as image settings metadata as mentioned above.

In some implementations, the user input controls include a control for enabling/disabling an autofocus mode. Autofocus mode enables the control apparatus 122 to adjust the focus of the optics 110 automatically based on the distance the device is from the sample surface 1. Alternatively, autofocus may be always-enabled.

FIG. 5 further illustrates a camera feed component 1024 configured to render a feed of the frames captured by the second optical image capture device 118. This enables the user to verify the quality of the footage of the scene that is being captured.

If the footage is dark, the user may actuate a user input control to activate the broadband white light source 114N. The user may optimise settings of the second optical image capture device 118 such as one or more of: brightness, contrast, saturation, hue, sharpness, gamma, exposure, white balance, backlight contrast.

The human-machine interface 102 may be configured to enable the intensity of the broadband white light source 114N to be varied between a plurality of levels. This enables the user (or the controller, if automatic) to lower the white light intensity so that the intensity is high enough to illuminate a portion of the scene (including the forensic sample/surface) for the second optical image capture device 118 and is low enough not to reduce the contrast/quality of the forensic images captured by the first optical image capture device 104. An advantage is a more robust evidentiary picture of the scene search and evidence recovery process, in dark environments.

In an example implementation, some emitters of the light source 114 may emit ultraviolet, infrared or narrowband visible light for the capture of forensic images by the first optical image capture device 104 (via a pass filter selected for enabling detection of fluorescence/reflectance/scattering resulting from the emitted ultraviolet/infrared/narrowband visible light), while low-intensity broadband white light is simultaneously emitted by the broadband white light source 114N for illuminating the forensic sample in the frames captured by the second optical image capture device 118.

In some examples, the feed from the second optical image capture device 118 is displayed simultaneously with the ‘live mode’ forensic images of the first optical image capture device 104.

FIG. 5 further illustrates an identification system component 1026 configured to render a user interface of an automatic identification system.

In examples, the automatic identification system comprises an automatic skin print identification system. The system may be able to identify fingerprints and as such may be referred to as an automatic fingerprint identification system (AFIS). In some examples, identification systems can be provided for other biometric/forensic data.

The automatic identification system may comprise a matching system. The matching system is configured to compare query data based on the forensic image with candidate forensic sample records (e.g., images) stored in a database. Based on the comparison, the matching system is configured to determine whether a similarity condition is satisfied. If the similarity condition is satisfied, the matching system will return to the forensic spectral imaging unit 100 a match indicator indicating whether the forensic sample 2 in the forensic image corresponds to a forensic sample 2 record stored in a database.

In examples, the comparison is a probabilistic comparison. The match indicator may provide information associated with the forensic sample record, such as an identity of a person.

The matching system of the automatic identification system may be hosted locally within the control apparatus 122 of the forensic spectral imaging unit 100, so that identification functions can be performed on-site without requiring network connectivity. Alternatively, the identification system component 1026 may comprise an application programming interface for a remotely-hosted automatic identification system (e.g., server-hosted, separated by a local and/or wide area network). The database accessed by the matching system may be stored either locally or remotely, in non-volatile memory.

The identification system component 1026 may be configured to render a user input control to enable a user to request that at least one forensic image of a skin print is provided from non-volatile memory to the matching system. The identification system component 1026 may receive in response, from the matching system, the match indicator.

The identification system component 1026 may then be configured to output match feedback based on the match indicator, for rendering by a user interface of the identification system component 1026. The match feedback may be automatically rendered immediately in response to receiving the match indicator. Alternatively, the match feedback may be stored and may be retrievable later.

The match feedback may provide the same or similar information as that of the match indicator. The match feedback may indicate the strength of the match, for example a probability score. The match feedback may indicate the identity of the person from the database.

An advantage of the ability to request matching feedback in realtime, during a forensic imaging session, is that the matching feedback may help the user to determine whether they have collected forensic images which is good enough quality. The matching feedback helps the user to determine whether higher-quality forensic images are required (e.g., additional images with different wavelengths/pass filters 112/sensor settings). The rapid feedback speeds up the identification of a suspect. This has benefits to civilian forensic investigations, and particularly to military forensic investigations where known targets could be rapidly identified while still in the field.

FIG. 10 schematically illustrates an example flowchart of a method 1000 for implementing the matching feedback. The method 1000 may be implemented by the control apparatus 122. The method comprises:
at block 1002, providing the at least one forensic image to a matching system;
at block 1004, receiving a match indicator indicating whether the forensic sample 2 in the at least one forensic image corresponds to a forensic sample in a database, according to the matching system; and
at block 1006, outputting match feedback based on the match indicator, for rendering by an output device (102) associated with the forensic spectral imaging unit 100.

Additionally, or alternatively, the automatic identification system may be configured to provide a feedback parameter indicating a quality of the forensic image. This can provide useful feedback to the user who may be unsure whether they have captured enough high quality forensic images with enough settings, to enable enough detail to be captured.

In a skin print implementation, the skin print identification system is configured to indicate the quality by analysing the forensic image to determine the number of detectable skin print minutiae points in the forensic image. Based on the analysis, the skin print identification system is configured to return a parameter dependent on how many skin print minutiae points are detected by the skin print identification system.

Minutiae points are sometimes referred to as ‘Level II detail’ or ‘Galton points’, relating to individual characteristics of individual friction ridge features. A feature may be a minutiae point if the feature falls into one of a plurality of known feature classes. Example feature classes include: an end point of a friction ridge; a bifurcation (or trifurcation) of an individual friction ridge; a ridge unit (dot); a short ridge; an island of empty space within a ridge; a spur (notch protruding from a ridge); a bridge joining adjacent ridges; and a crossover between two ridges.

In some examples, the parameter may indicate the number of detected minutiae points. In some examples, the parameter may indicate whether the number of detected minutiae points satisfies a condition (e.g., minimum threshold). A minimum threshold of approximately six minutiae points indicates that matching is possible, and a higher number of minutiae points, such as 16 or 25, indicates the forensic image is of especially good quality for the matching system.

The analysis may be performed locally within the control apparatus 122 of the forensic spectral imaging unit 100, so that quality analysis can be performed on-site without requiring network connectivity. Alternatively, the analysis may be performed remotely

The identification system component 1026 may be configured to render a user input control to enable a user to request that at least one forensic image of a skin print is provided from non-volatile memory to the skin print identification system so that the quality analysis can be carried out. The identification system component 1026 may receive in response, from the skin print identification system, the parameter dependent on the number of skin print minutiae points detected by the skin print identification system.

The identification system component 1026 may then be configured to output feedback based on the parameter, for rendering by a user interface of the identification system component 1026. The feedback may provide the same or similar information as that of the parameter. The feedback may be automatically rendered immediately in response to receiving the parameter. Alternatively, the feedback may be stored and may be retrievable later.

The above example refers to skin print minutiae points. Additionally, or alternatively, the skin print identification system may analyse Level I skin print detail and/or Level III skin print detail to determine the quality.

Level I detail relates to group characteristics of a plurality of friction ridges. For example, a path of one or more friction ridges of non-trivial length may form a shape, and other surrounding friction ridges may deflect around the shape. A shape may be Level I detail if the shape falls into one of a plurality of known shape classes. Example shape classes include: deltas; whorls; loops; arches; and palmar vestiges.

Level III detail includes dimensional attributes of individual friction ridges. Examples of dimensional attributes include: pores; incipient friction ridges; friction ridge edge contours/protrusions; friction ridge width; friction ridge shape; friction ridge breaks; flexion creases; and scars.

FIG. 9 schematically illustrates an example flowchart of a method 900 for implementing the quality-based feedback. The method 900 may be implemented by the control apparatus 122. The method comprises:
at block 902, providing at least one forensic image to a skin print identification system, wherein the forensic sample 2 is a skin print;
at block 904, receiving a parameter dependent on how many skin print minutiae points are detected by the skin print identification system; and
at block 906, outputting feedback based on the parameter, for rendering by an output device (102) associated with the forensic spectral imaging unit 100.

FIG. 5 further illustrates additional components such as a filter exchange control component 1028; a light source control component 1030; and/or a data folder component 1032.

The filter exchange control component 1028 may be configured to render a user input control to enable the user to select a pass filter 112. In response to selection of a pass filter 112, the control apparatus 122 may be configured to control the filter wheel 108 to align the selected pass filter 112 with an optical axis of the first optical image capture device 104.

The light source control component 1030 may be configured to render a user input control to enable the user to select a wavelength to be output by the light source 114, and/or to select a plurality of different predetermined wavelengths to be concurrently output by different emitters of the light source 114. The different wavelength options each correspond to a different subset of emitters of the light source 114 to be activated. In the ring light example, the user can independently turn each light emitter or group of light emitters on or off, as well as control the brightness (intensity) of each switched-on emitter or group separately and independently. This enables the mix of different wavelengths (e.g., 365 nm, 450 nm, 530 nm, 570 nm, white) to be finely controlled.

The forensic spectral imaging unit 100 may be preprogrammed with one or more imaging acquisition operations, each involving the use of one or more preset wavelengths of the light source 114 and the use of one or more pass filters 112 of the first optical image capture device 104. The preprogrammed imaging acquisition operation(s) may include the simultaneous or sequential capture of multiple images of the finger mark and the sample surface 1. In this way a preprogrammed imaging acquisition operation can be selected before taking the image(s) of the finger mark and the sample surface 1, thus reducing the time required to set up the forensic spectral imaging unit 100.

The data folder component 1032 may be configured to render a user interface to enable a user to navigate data folders and access stored forensic images, frames and/or metadata.

In examples, the control apparatus 122 may include an electronic image processing circuit programmed to carry out image processing of the or each captured forensic image. This enables the image processing to be carried out in the forensic spectral imaging unit 100 itself, thus enhancing its field deployability. In other examples, the image processing is carried out remotely, e.g., at a server.

In some examples, the image processing circuit may form part of the automatic identification system. The image comparison may be carried out after the aforementioned image manipulation.

Water content of a finger mark is another target constituent that can undergo fluorescence, absorption, reflectance or scattering events at certain wavelengths in the visualisation and image capture of the finger mark using the forensic spectral imaging unit 100.

The forensic spectral imaging unit 100 is capable of using the absorption and fluorescent properties associated with post-blast finger marks to reliably and repeatably recover finger mark evidence from fragments and debris at post-blast bomb scenes. More specifically, this is achieved due to the fluorescent, absorption, scattering and reflectance properties of eccrine and sebaceous sweat inducing or acting as a barrier to corrosion/oxidation (such as on metal IEDs), which offers sufficient optical difference as a result of the debris surface chemistry to enable high quality imaging of the associated finger mark. The inventor has found that the forensic spectral imaging unit 100 detected that fats within finger marks and finger prints polymerise and plasticise during an explosion event, which is not detectable by conventional forensic techniques. The forensic spectral imaging unit 100 is able to recover finger mark evidence from pipe, vehicle, backpack and suicide-vest bombs with a success rate of 65%, which is far ahead of conventional post-blast recovery techniques that have success rates of 2%.

Semen is another important trace evidence type due to the ability to obtain DNA that can be used to identify an individual. Like blood, there are presumptive and confirmatory tests for identifying and confirming semen, but many conventional tests are destructive and can destroy DNA. The forensic spectral imaging unit 100 can be used to carry out non-contact, non-destructive imaging of semen deposited on various sample surfaces. In particular, the forensic spectral imaging unit 100 may be used to expose the semen sample to UV light so as to cause the semen to undergo fluorescence and then capturing one or more images of the fluorescing semen with the first optical image capture device 104 using one or more pass filters 112 having visible light wavelength bands.

Food fraud has become a growing area of investigation to combat adulteration, fakery and fraud. For example, considering saffron, the absorption characteristics associated with real saffron constituents (257 nm for picrocrocin, 330 nm for safranal and 440 nm for crocin) may be tested by selection of appropriate emission wavelengths. For example, wavelengths can include 302 nm and 365 nm sources.

FIG. 7 illustrates an example of a controller 122. Implementation of a controller 122 may be as controller circuitry. The controller 122 may be implemented in hardware alone, have certain aspects in software including firmware alone or can be a combination of hardware and software (including firmware).

As illustrated in FIG. 7 the controller 122 may be implemented using instructions that enable hardware functionality, for example, by using executable instructions of a computer program 208 in a general-purpose or special-purpose processor 204 that may be stored on a computer readable storage medium (disk, memory etc) to be executed by such a processor 204.

The processor 204 is configured to read from and write to the memory 206. The processor 204 may also comprise an output interface via which data and/or commands are output by the processor 204 and an input interface via which data and/or commands are input to the processor 204. The memory 206 may be the non-volatile memory referred to in earlier in the specification. In other examples, at least some data is stored off-board the device in remote non-volatile memory.

The memory 206 stores a computer program 208 comprising computer program instructions (computer program code) that controls the operation of the control apparatus 122 when loaded into the processor 204. The computer program instructions, of the computer program 208, provide the logic and routines that enables the control apparatus 122 to perform the methods illustrated in FIGS. 9-11. The processor 204 by reading the memory 206 is able to load and execute the computer program 208.

The control apparatus 122 therefore comprises:
at least one processor 204; and
at least one memory 206 including computer program code
the at least one memory 206 and the computer program code configured to, with the at least one processor 204, cause the control apparatus 122 at least to perform the method 1100 of FIG. 11:
   at block 1102, capturing visible light frames of the scene with the second optical image capture device 118, at one or more times including at the first time;
   at block 1104, exposing the forensic sample 2 and the sample surface 1 to the light source 114 to cause one or more of absorption, fluorescence, reflectance and scattering by the forensic sample 2 and/or the sample surface 1; and
   at block 1106, capturing at the first time the at least one forensic image of the forensic sample 2 and/or the sample surface 1 with the first optical image capture device 104 using the at least one pass filter 112 having a wavelength band that corresponds to a wavelength of the absorption, fluorescence, reflectance and/or scattering by the forensic sample 2 and/or the sample surface 1.

As illustrated in FIG. 8, the computer program 208 may arrive at the control apparatus 122 via any suitable delivery mechanism 300. The delivery mechanism 300 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 208. The delivery mechanism may be a signal configured to reliably transfer the computer program 208. The control apparatus 122 may propagate or transmit the computer program 208 as a computer data signal.

Computer program instructions for causing a control apparatus 122 to perform at least the following or for performing at least the following:
causing capturing of visible light frames of the scene with the second optical image capture device 118, at one or more times including at the first time;
causing exposing the forensic sample 2 and the sample surface 1 to the light source 114 to cause one or more of absorption, fluorescence, reflectance and scattering by the forensic sample 2 and/or the sample surface 1; and
causing capturing at the first time the at least one forensic image of the forensic sample 2 and/or the sample surface 1 with the first optical image capture device 104 using the at least one pass filter 112 having a wavelength band that corresponds to a wavelength of the absorption, fluorescence, reflectance and/or scattering by the forensic sample 2 and/or the sample surface 1.

The computer program instructions may be comprised in a computer program, a non-transitory computer readable medium, a computer program product, a machine readable medium. In some but not necessarily all examples, the computer program instructions may be distributed over more than one computer program.

Although the memory 206 is illustrated as a single component/circuitry it may be implemented as one or more separate components/circuitry some or all of which may be integrated/removable and/or may provide permanent/semi-permanent/dynamic/cached storage.

Although the processor 204 is illustrated as a single component/circuitry it may be implemented as one or more separate components/circuitry some or all of which may be integrated/removable. The processor 204 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The blocks illustrated in the FIGS. 9-11 may represent steps in a method and/or sections of code in the computer program 208. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The recording of data may comprise only temporary recording, or it may comprise permanent recording or it may comprise both temporary recording and permanent recording, Temporary recording implies the recording of data temporarily. This may, for example, occur during sensing or image capture, occur at a dynamic memory, occur at a buffer such as a circular buffer, a register, a cache or similar. Permanent recording implies that the data is in the form of an addressable data structure that is retrievable from an addressable memory space and can therefore be stored and retrieved until deleted or over-written, although long-term storage may or may not occur. The use of the term ‘capture’ in relation to an image relates to temporary recording of the data of the image. The use of the term ‘store’ in relation to an image relates to permanent recording of the data of the image.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

FIG. 12 illustrates an example method 1200 of querying a bloodstain pattern analysis system to obtain an automatic prediction of the source of bloodstains, and to guide the user towards the predicted source location. The method 1200 may be implemented by the control apparatus 122.

The method 1200 comprises:
at block 1202, providing the at least one forensic image to a bloodstain pattern analysis system, wherein the forensic sample is a directional blood droplet;
at block 1204, receiving a parameter from the bloodstain pattern analysis system, wherein the parameter is indicative of a source location of the forensic sample based on a shape of the directional blood droplet; and
at block 1206, outputting guidance based on the parameter, to be rendered by the output device of the human-machine interface 102 to guide a user of the forensic spectral imaging unit 100 towards the source location.

FIG. 13 illustrates an example forensic image 1302 showing a bloodstain suitable for the method 1200. The bloodstain in FIG. 13 comprises a directional droplet 1304. The elongate shape of the droplet indicates that the droplet is a directional droplet. The direction in which the droplet is elongated indicates the direction from which the droplet came. The aspect ratio of the droplet is an indicator of the horizontal velocity of the droplet as it fell.

The bloodstain pattern analysis system can be configured to determine at least the direction, and optionally the probable source location of a directional blood droplet based on any one or more of the above characteristics. The control apparatus can further be configured to determine whether an imaged droplet is blood, based on the predetermined absorption and fluorescent spectral characteristics of blood, and various stages of oxidation. A similar analysis system may be provided to recognise semen.

The bloodstain pattern analysis system can comprise a trained machine learning algorithm. The trained machine learning algorithm can determine the probable source location of one or more blood droplets. The trained machine learning algorithm can further determine whether an imaged droplet comprises blood. In examples, the determinations are probabilistic. The bloodstain pattern analysis system may be configured to determine the probable common source location of a plurality of blood droplets, at least one of which may be directional in shape. More blood droplets can improve the accuracy and precision of the determined probable source location.

FIG. 5 further illustrates the human-machine interface 102 comprising a blood pattern analysis component 1034 configured to render a user interface of a bloodstain pattern analysis system. This enables live, real-time and automated bloodstain pattern analysis.

The bloodstain pattern analysis system may be hosted locally within the control apparatus 122 of the forensic spectral imaging unit 100, so that its functions can be performed on-site without requiring network connectivity. Alternatively, the blood pattern analysis component 1034 may comprise an application programming interface for a remotely-hosted bloodstain pattern analysis system (e.g., server-hosted, separated by a local and/or wide area network).

The blood pattern analysis component 1034 may be configured to render a user input control to enable a user to request that at least one forensic image of a suspected bloodstain is provided from non-volatile memory to the bloodstain pattern analysis system.

In some examples, a plurality of forensic images can be selected via the human-machine interface 102, to be analysed together by the bloodstain pattern analysis system. The forensic images may show different bloodstains at different locations. The bloodstain pattern analysis system may be configured to determine the source location with greater confidence if the bloodstains comprise droplets originating from a same source location.

When the bloodstain pattern analysis system has determined a probable source location of one or more blood droplets, it returns the parameter indicating the (probable/suspected) source location of the bloodstain or stains. The source location may be a point in two-dimensional or three-dimensional space. In a three-dimensional implementation, the source location may comprise an area or point having x, y, z coordinates. In examples, the source location can be determined in dependence on a three-dimensional reconstruction of the scene or scenes captured by a depth sensor 138 shown in FIG. 1.

The parameter output by the bloodstain pattern analysis system may be converted by the control apparatus 122 into rendered guidance to guide the user towards the source location. The guidance may be rendered anywhere on the human-machine interface 102. The guidance may take any suitable form such as an arrow, or a tracer line. The guidance may be displayed in augmented reality, virtual reality, or mixed reality, simultaneously to the real-time footage captured by the first and/or second optical image capture devices 104, 118.

The guidance may be overlaid onto real-time displayed footage or still images from the first and/or second optical image capture devices 104, 118, or a below-described depth sensor 138.

The guidance would highlight a position within the image(s) of where the probable source location is situated with a location indicator, such as a circle or other closed shape. The size of the location indicator may change depending on the certainty of the probable source location. For example, a smaller closed shape would represent a higher certainty

The guidance may be rendered in real-time, during a forensic imaging session. This helps the user in the search process to determine the best places to look for evidence.

The forensic spectral imaging unit 100 may comprise a depth sensor 138. The depth sensor 138 may comprise a time of flight sensor or a light detection and ranging (LIDAR) sensor. The depth sensor 138 may be configured to record while the other sensors are recording. The depth sensor 138 produces a depth map which may form an image channel of the forensic image. Alternatively, a simpler time of flight depth sensor 138 produces a measurement of a working distance of the forensic sample from the depth sensor, without producing a depth map.

The control apparatus 122 may be configured to convert the depth map to point cloud data to enable a three-dimensional reconstruction of the scene. The depth sensor 138 may be configured to detect wavelengths in the region approx. 800 nm to 1100 nm, which can offer some additional benefit for the accurate depth mapping of various types of evidence. An infrared and/or near-infrared source in this wavelength region may be active while the depth sensor 138 is recording.

The three-dimensional reconstruction of the scene may be used by various functions such as the bloodstain pattern analysis system, or the overlaying of 3D information as described below.

As shown in FIG. 13, the control apparatus 122 may be configured to determine a scale based on the depth map or the measurement of working distance, and automatically (without user intervention) overlay a scale indicator 1306 within the forensic image to indicate a size of the forensic sample. FIG. 13 shows a scale indicator 1306 displaying the scale in the form of ruler markings. The control apparatus may store in non-volatile memory the forensic image comprising the overlaid scale indicator 1306.

The control apparatus 122 may be configured to determine a plausibility of the depth information from the depth sensor. Determining the plausibility may be based on a predetermined working distance range calculated from the focus and aperture settings of the lens 111 at the time the forensic image was taken. If the plausibility check passes (i.e. the depth sensor measurement falls within, or within a % of, the working distance range calculated from the lens settings) then the depth sensor measurement will be used to add the scalebar to the forensic image and this will be saved in non-volatile memory as a new file. If the plausibility check fails then it is assumed that the depth sensor measurement is erroneous. In this case the lens working distance calculation will be used (the centre point in the working distance range) and a warning will be rendered to the user to let them know of the potential reduced accuracy of the scalebar

The forensic spectral imaging unit 100 may comprise a still image capture trigger (not shown), such as a button or touchscreen control, for causing the first and/or second optical image capture device 104, 118 to record a still image in non-volatile memory. A single actuation of the still image capture trigger may cause simultaneous capture and recordal of still images by both the first and second optical image capture devices 104, 118 in non-volatile memory. Video recording by the devices 104, 118 may be uninterrupted by actuation of the still image capture trigger.

Referring now to FIG. 14, the control apparatus 122 may be configured to combine images by overlaying a still forensic image 1404 captured by the first optical image capture device onto a secondary, scene image 1402 captured by the second optical image capture device captured at substantially the same time. The combining may be performed automatically based on user actuation of the still image capture trigger. FIG. 14 shows the resulting combined image 1400.

The known predetermined relative positions, orientations, and fields of view of the first and second optical image capture devices means that the position of the forensic image 1404 within the scene image 1402 can be determined automatically, so that the forensic sample from the forensic image 1404 replaces the fainter/invisible forensic sample in the scene image 1402. The control apparatus 122 may be configured to store the combined image 1400 in non-volatile memory. The control apparatus 122 may be configured to display the combined image 1400 on the display.

If the scene image 1404 is a three-dimensional image as described above, the forensic image 1404 may be overlaid at a depth corresponding to the distance of the forensic sample within the depth map.

In some examples, the control apparatus 122 is configured to render the earlier-described guidance (see for example FIG. 13) in the combined image 1400 of FIG. 14. In some examples, the guidance may be rendered in the scene image 1402 of the combined image 1400. In some examples, the guidance may be rendered at a position within the scene image 1402 corresponding to a position of the probable source location within the scene image 1402, or may point towards said position of the probable source location. In some examples, if the position of the probable source location is outside a field of view of the scene image 1402, the guidance may indicate a direction of the probable source location outside the field of view.

As shown in FIG. 1, the first optical image capture device 104 may comprise a removable ultraviolet polariser 136 to reduce ultraviolet reflections, e.g., from sunlight. The removable ultraviolet polariser 136 may be securable to the front of the lens 111. The removable ultraviolet polariser 136 may be securable via a screw-fit connection, or any other appropriate connection. Therefore, the removable ultraviolet polariser 136 can be unscrewed/disconnected by a user when its absence is preferred.

In some examples, the control apparatus 122 is operable in a plurality of modes, each mode controlling settings such as a wavelength of the light source, a pass filter selection, and/or any of the image settings described herein. Mode selection may be via the human-machine interface 102.

In a fingermark mode and/or bodily fluid mode, the control apparatus 122 may be configured to enable selection of one or more presets. Each preset may comprise a different combination of a pass filter and a wavelength of the light source and image settings of the imaging sensor. There may be multiple presets for each mode, each for a different type of evidence.

In a post-blast mode of the plurality of modes, the control apparatus 122 may be configured to select a higher exposure time of the imaging sensor. This is because the spectral information is of much reduced quantity and/or quality, in terms of absorption, fluorescence, reflection and/or scatter.

In a manual mode of the plurality of modes, the control apparatus 122 may be configured to enable manual control of two or more of the following settings: a wavelength of the light source; a pass filter selection; image settings of the imaging sensor.

The modes may be selectable manually through the human-machine interface 102. Additionally, or alternatively, the modes can be selectable automatically by the control apparatus 122 based on image processing. For example, detection of a faint fingermark may automatically trigger selection of a fingermark mode.

In an implementation, the fingermark mode may automatically select:
a pass filter having a wavelength band having a value selected from the group comprising: UV wavelengths between 250 nm and 380 nm, Violet wavelengths between 380 nm and 420 nm, visible wavelengths between 420 nm and 800 nm, and/or near infrared wavelengths between 800 nm and 1100 nm;
the pass filter may be hyperspectral or non-hyperspectral;
a light source wavelength having a value selected from the group comprising: UV wavelengths between 250 nm and 380 nm, Violet wavelengths between 380 nm and 420 nm, visible wavelengths between 420 nm and 800 nm, and/or near infrared wavelengths between 800 nm and 1100 nm;
one or more image settings, relative to the other modes, the image settings selected from the group comprising: exposure, luminance, aperture and/or focus automatically adjusted dependent on surface.

In an implementation, the bodily fluid mode may automatically select:
a different pass filter, relative to other modes, having a wavelength band having a value selected from the group comprising: UV wavelengths between 300 nm and 380 nm, Violet wavelengths between 380 nm and 420 nm, visible wavelengths between 420 nm and 800 nm, and/or near infrared wavelengths between 800 nm and 1100 nm;
the pass filter may be hyperspectral or non-hyperspectral;
a different light source wavelength, relative to other modes, having a value selected from the group comprising: UV wavelengths between 250 nm and 380 nm, Violet wavelengths between 380 nm and 420 nm, visible wavelengths between 420 nm and 800 nm, and/or near infrared wavelengths between 800 nm and 1100 nm;
one or more different image settings, relative to the other modes, the image settings selected from the group comprising: exposure, luminance, aperture and/or focus automatically adjusted dependent on surface.

In an implementation, the post-blast mode may automatically select:
a different pass filter, relative to other modes, having a wavelength band having a value selected from the group comprising: UV wavelengths between 250 nm and 380 nm, Violet wavelengths between 380 nm and 420 nm, visible wavelengths between 420 nm and 800 nm, and/or near infrared wavelengths between 800 nm and 1100 nm;
the pass filter may be hyperspectral or non-hyperspectral;
a different light source wavelength, relative to other modes, having a value selected from the group comprising: UV wavelengths between 250 nm and 380 nm, Violet wavelengths between 380 nm and 420 nm, visible wavelengths between 420 nm and 800 nm, and/or near infrared wavelengths between 800 nm and 1100 nm;
one or more different image settings, relative to the other modes, the image settings selected from the group comprising: a longer exposure time as described above; exposure time including extended exposure, luminance, aperture and/or focus automatically adjusted dependent on surface.

Table 1 earlier in the description identifies example specific wavelength values for the light source 113 and which mode(s) they could be used in. Further, 254 nm and 302 nm wavelengths are particularly effective for post-blast imaging of fingermarks.

For each mode, the automatically selected pass filter 112 may have a wavelength band sensitive to the automatically selected light source wavelength.

In some examples, each mode has two user-selectable sub-modes: search mode and capture mode. Search mode may be for a wide range of possible surfaces, whereas capture mode may be for specific selected surface types. For example, transitioning from search mode to capture mode may comprise causing switching from a non-hyperspectral filter to a hyperspectral filter. A non-hyperspectral filter can be used for both fingermarks and bodily fluids, whereas hyperspectral filters may be for fingermarks or for bodily fluids. The light source and image settings may also be different between search mode and capture mode.

During the scene search process, any one of the above modes may be used. If the environment is dark, the broadband white light source may be activated manually or automatically. At the same time as broadband white light is emitted, a further one of the light sources, such as the infrared or near-infrared light emitter 114A and/or ultraviolet light emitter 114B, may be active to illuminate samples. The broadband white light source N may be independently controllable relative to the other emitters. The white light source may in certain scenarios also be the only light source used.

In some examples, a user may carry with them a set of barcode-carrying items, such as a roll of paper barcodes each having a unique barcode identity. This is to help with the docketing of evidence. The user places a paper barcode within the field of view of one or both of the optical image capture devices 104, 118, so that it can be seen in the images. To promote easy and automatic digital docketing of evidence, the above-described image settings metadata of the images from the first and/or second optical image capture devices 104, 118 may comprise a barcode identity. The user can use the human-machine interface to enter the barcode identity (e.g., number) to be saved in the non-volatile memory as metadata. Alternatively, this may be done automatically through image processing.

Another image processing function is the ability via the human-machine interface 102 to manually post-process the forensic image/combined image based on any of the image settings described herein. The post-processed image may be displayed to the user in real-time by the human-machine interface 102. For example, a user can apply a negative transformation to make the images easier to interpret. A user can change brightness or contrast to check whether the forensic sample can be made sufficiently clear relative to its background.

The forensic spectral imaging unit 100 may further comprise a physical and/or wireless display port (not shown) to enable connection of the forensic spectral imaging unit to an external display. An advantage is that evidence can be assessed at the scene on a larger screen, or in a laboratory.

To prevent glare in-use, the forensic spectral imaging unit may comprise a hood (not shown) above the human-machine interface (e.g., display). The hood may protrude away from the plane of the display.

It would be appreciated that the light source 114 does not have to comprise a ring light 113. Additionally, or alternatively, the light emitters may be arranged in another manner such as in arrays. The light source placement may comprise grouped arrays of LEDs on the front face of the housing 101 above and/or beside the aperture of the lens 111 of the first optical image capture device 104 in addition to tube lamps on the front face of the housing 111 above and/or beside the aperture of the lens 111 of the first optical image capture device 104.

The light source 113 may comprise a plurality of groups of light emitters. Each group can comprise a plurality of light sources each group having a different emission wavelength than each other group.

Although examples have been described in the preceding paragraphs with reference to various examples, it should be appreciated that modifications to the examples given can be made without departing from the scope of the claims. For example, the methods of FIG. 9 or 10 or 12 may be patentable of their own right, whether or not the forensic spectral imaging device comprises a second optical image capture device 118.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. A forensic spectral imaging unit for carrying out non-contact, non-destructive imaging of a forensic sample deposited on a sample surface, the forensic spectral imaging unit comprising:
a light source having at least one wavelength that is capable of causing one or more of absorption, fluorescence, reflectance or scattering by at least one of the forensic sample or the sample surface;
a first optical image capture device having a first field of view, for capturing at a first time at least one forensic image of the at least one of the forensic sample or the sample surface, within a scene, wherein the optical image capture device includes at least one pass filter having a wavelength band that corresponds to a wavelength of the one or more of absorption, fluorescence, reflectance or scattering by the at least one of the forensic sample or the sample surface, the at least one pass filter including a first pass filter being of hyperspectral sensitivity; and
a second optical image capture device having a second field of view wider than the first field of view, for capturing one or more visible light frames of the scene at one or more times including at the first time.

2.-6. (canceled)

7. The forensic spectral imaging unit of claim 1, the light source comprising a broadband white light source and one or more other emitters, wherein the forensic spectral imaging unit is configured to vary an intensity of the broadband white light source, and wherein the broadband white light source is configured to emit controlled-intensity white light while the one or more other emitters of the light source simultaneously emit at least one of: ultraviolet light; infrared light; near-infrared light; or narrowband visible light.

8.-9. (canceled)

10. The forensic spectral imaging unit of claim 1, comprising a control apparatus having a controller, the control apparatus configured to control operations of the light source and the first optical image capture device and the second optical image capture device, wherein the control apparatus is user-operable to control the first optical image capture device to capture forensic images while the second optical image capture device continuously captures visible light frames as footage.

11.-13. (canceled)

14. The forensic spectral imaging unit of claim 1, comprising a depth sensor and a control apparatus having a controller, the control apparatus configured to control operations of the light source and the first optical image capture device and the second optical image capture device, wherein the control apparatus is configured to store a depth map or a measurement of working distance, in combination with the at least one forensic image.

15. The forensic spectral imaging unit of claim 14, wherein the control apparatus is configured to overlay a distance scale indicator with the at least one forensic image based on depth information from the depth sensor.

16. The forensic spectral imaging unit of claim 1, comprising a control apparatus having a controller, the control apparatus configured to control operations of the light source and the first optical image capture device and the second optical image capture device, wherein the control apparatus is operable in a plurality of modes, each mode controlling two or more of the following settings:
a wavelength of the light source;
a pass filter selection from a plurality of pass filters; or
image settings of an imaging sensor of the first optical image capture device.

17. The forensic spectral imaging unit of claim 1, comprising a control apparatus having a controller, the control apparatus configured to control operations of the light source and the first optical image capture device and the second optical image capture device, wherein the control apparatus is configured to combine the at least one forensic image with a secondary image captured by the second optical image capture device to form a combined image, in which the position of the forensic sample from the at least one forensic image corresponds to the position of the forensic sample from the secondary image, and wherein the control apparatus is configured to store the combined image in non-volatile memory.

18. (canceled)

19. The forensic spectral imaging unit of claim 17, wherein the secondary image is a three-dimensional image, wherein combining the at least one forensic image with the secondary image comprises overlaying the at least one forensic image onto the secondary image, and wherein combining the at least one forensic image with the secondary image comprises overlaying the at least one forensic image at a three-dimensional position within the secondary image.

20. The forensic spectral imaging unit of claim 1, comprising a control apparatus having a controller, the control apparatus configured to control operations of the light source and the first optical image capture device and the second optical image capture device, wherein the control apparatus is configured to store a barcode identity as metadata for the at least one forensic image.

21.-26. (canceled)

27. The forensic spectral imaging unit of claim 1, wherein the first optical image capture device includes a plurality of pass filters to configure the forensic spectral imaging unit, the plurality of pass filters including the first pass filter, each pass filter having a respective wavelength band that corresponds to a wavelength of the one or more of absorption, fluorescence, reflectance or scattering by the at least one of the forensic sample or the sample surface, wherein the plurality of pass filters includes a second pass filter having a full width at half maximum greater than 10 nanometres.

28. The forensic spectral imaging unit of claim 27, wherein the second pass filter has a full width at half maximum greater than 25 nanometres.

29. The forensic spectral imaging unit of claim 27, wherein the plurality of pass filters includes a first plurality of pass filters having a full width at half maximum less than or equal to 10 nanometres, including the first pass filter, and a second plurality of pass filters having a full width at half maximum greater than 10 nanometres, including the second pass filter.

30. The forensic spectral imaging unit of claim 29, wherein the first plurality of pass filters have non-overlapping bands compared to each other, and wherein the second plurality of pass filters have non-overlapping bands compared to each other.

31.-35. (canceled)

36. The forensic spectral imaging unit according to claim 1, wherein the forensic spectral imaging unit is handheld.

37. (canceled)

38. A method of operating a forensic spectral imaging unit to carry out non-contact, non-destructive imaging of a forensic sample deposited on a sample surface, the forensic spectral imaging unit in accordance with claim 1, the method comprising:
capturing visible light frames of the scene with the second optical image capture device, at one or more times including at the first time;
exposing the forensic sample and the sample surface to the light source to cause one or more of absorption, fluorescence, reflectance or scattering by at least one of the forensic sample or the sample surface; and
capturing at the first time the at least one forensic image of the at least one of the forensic sample or the sample surface with the first optical image capture device using the at least one pass filter having a wavelength band that corresponds to a wavelength of the one or more of absorption, fluorescence, reflectance or scattering by the at least one of the forensic sample or the sample surface, the at least one pass filter including a first pass filter being of hyperspectral sensitivity.

39. A forensic spectral imaging unit for carrying out non-contact, non-destructive imaging of a forensic sample deposited on a sample surface, the forensic spectral imaging unit comprising:
a light source having at least one wavelength that is capable of causing one or more of absorption, fluorescence, reflectance and scattering by at least one of the forensic sample or the sample surface; and
a first optical image capture device having a first field of view, for capturing at a first time at least one forensic image of the at least one of forensic sample or the sample surface, within a scene, wherein the optical image capture device includes at least one pass filter having a wavelength band that corresponds to a wavelength of the one or more of absorption, fluorescence, reflectance or scattering by the at least one of the forensic sample or the sample surface, the at least one pass filter including a first pass filter being of hyperspectral sensitivity.

40. The forensic spectral imaging unit of claim 39, further comprising one or more of:
a location sensor configured to detect a location of the forensic spectral imaging unit, and to provide information indicative of the location as metadata for the at least one forensic image;
an onboard clock apparatus configured to provide timestamp information as metadata for the at least one forensic image; or
a controller configured to provide image settings information as metadata for the at least one forensic image.

41. The forensic spectral imaging unit of claim 39, wherein the first optical image capture device includes a plurality of pass filters to configure the forensic spectral imaging unit, the plurality of pass filters including the first pass filter, each pass filter having a respective wavelength band that corresponds to a wavelength of the one or more of absorption, fluorescence, reflectance or scattering by the at least one of the forensic sample or the sample surface, wherein the plurality of pass filters further includes a second pass filter having a full width at half maximum greater than 10 nanometres.

42. The forensic spectral imaging unit of claim 41, wherein the second pass filter has a full width at half maximum greater than 25 nanometres.

43. The forensic spectral imaging unit of claim 39, comprising a depth sensor and a control apparatus having a controller, the control apparatus configured to control operations of the light source and the first optical image capture device and the second optical image capture device, wherein the control apparatus is configured to store a depth map or a measurement of working distance, in combination with the at least one forensic image, and wherein the control apparatus is configured to overlay a distance scale indicator with the at least one forensic image based on depth information from the depth sensor.
